(19) United States
(12) Patent Application Publication
(10) Pub. No.: US 2007/0235983 A1
(43) Pub. Date: Oct. 11, 2007

(54) Trailer hitch cover

(76) Inventor: Robert Braun, Ames, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/394,420

(22) Filed: Mar. 31, 2006

(51) Int. Cl. B60D 1/60

(52) U.S. Cl. 280/507

(57) ABSTRACT

A cover for a fifth wheel trailer hitch is provided. The cover surrounds substantially all of the hitch head and kingpin and acts to lessen or prevent injuries sustained from collision with the trailer hitch when the trailer is detached from a towing vehicle. The cover is a sleeve made from a soft, resilient material such as foam rubber that slides over the hitch head and kingpin.

### BACKGROUND OF THE INVENTION

The invention relates generally to a cover for a fifth wheel trailer hitch, and, more particularly, to a protective cover that substantially covers the hitch head and kingpin of a fifth wheel trailer in order to prevent or minimize injury sustained from colliding with the hitch head or kingpin.

Fifth wheel trailers are commonly used for towing recreational vehicles, as well as livestock trailers, flatbeds, and cargo trailers. The hitch of these trailers includes a hitch head, which extends vertically and downward from the overhang of the trailer, and a kingpin that is received in a connector on the towing vehicle. When the trailer is not being towed, users generally detach the trailer from the towing vehicle, leaving the hitch head and kingpin exposed as they extend from the overhang of the trailer. The exposed hitch head and kingpin create risk to persons moving around in the front of the trailer or around the overhang. Children are particularly at risk for injury, as the exposed hitch head and kingpin may be at approximately head-height.

The prior art includes hitch covers made of rubber or similarly hard materials that cover only the kingpin, thereby not addressing the risk of injury from collision with the hitch head. The hard materials also do little to minimize injury. Some prior art covers are designed to protect the kingpin itself from damage, including damage from the elements. The prior art does not demonstrate a soft, protective hitch cover that covers substantially all of the hitch head and kingpin.

### SUMMARY OF THE INVENTION

An object of the present invention is to provide a protective cover for a fifth wheel trailer hitch.

A further object of the present invention is to provide a protective cover for a fifth wheel trailer hitch wherein the cover covers substantially all of the hitch head and kingpin.

Another object of the present invention is to provide a protective cover for a fifth wheel trailer hitch that protects people from injuries sustained from colliding with the hitch head or kingpin.

These and other objects of the present invention will become apparent to those skilled in the art upon reference to the following specification, drawings, and claims.

The present invention intends to overcome the difficulties encountered heretofore. To that end, a protective cover or sleeve for a fifth wheel hitch is provided wherein the invention comprises a protective sleeve that covers substantially all of the hitch head and kingpin, thus minimizing injury if a person collides with the hitch head or kingpin.

### BRIEF DESCRIPTION OF THE DRAWINGS

FIG. 1 is a perspective view of a fifth wheel trailer

FIG. 2 is a front elevation view of the fifth wheel trailer hitch with the present invention covering the hitch head and kingpin.

FIG. 3 is a perspective view of the present invention shown removed from the fifth wheel trailer hitch.

FIG. 4 is a side elevation view of the present invention detailing its orientation and location in respect to a typical fifth wheel trailer hitch.

FIG. 5 is a rear elevation view of the present invention showing the slit in the bottom of the protective sleeve.

FIG. 6 is a view of the protective cover and securing strap of the present invention.

### DETAILED DESCRIPTION OF THE INVENTION

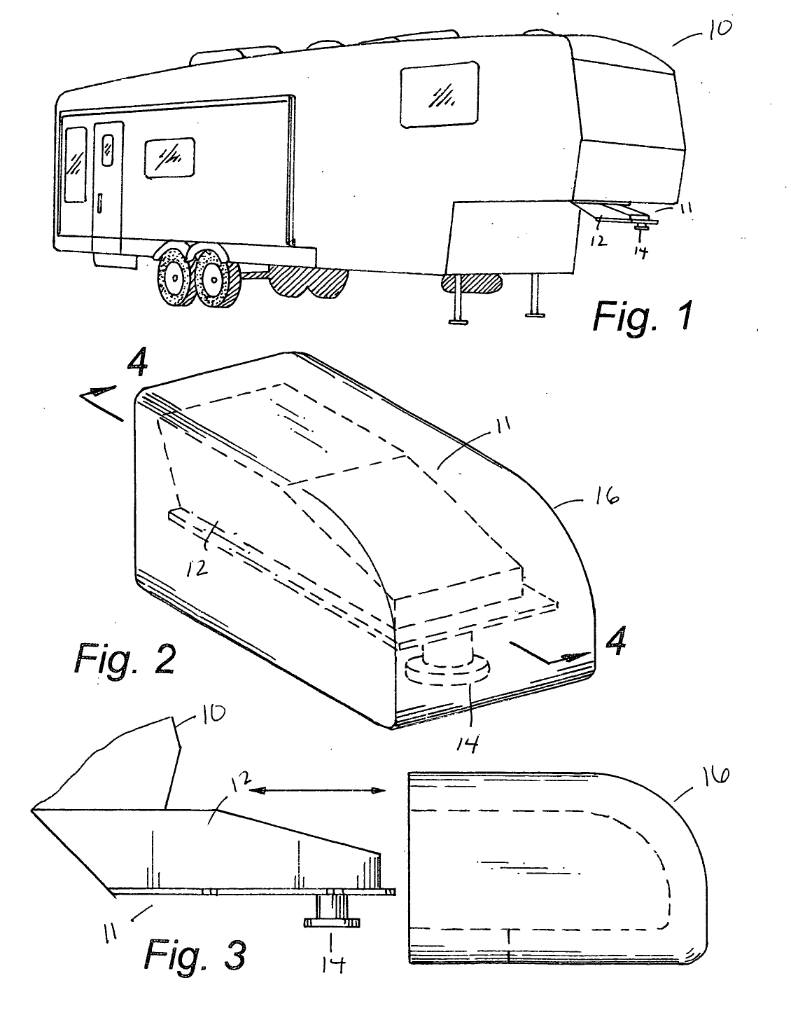

Illustrated in FIG. 1 is a trailer 10 of the type for which the present invention is designed for use. The trailer 10 has a hitch 11, which includes a hitch head 12 and a kingpin 14, used to attach the trailer 10 to a towing vehicle. The present invention is used when the trailer 10 has been detached from the towing vehicle, thus creating a risk of injury to those moving around the front of the trailer 10 in the vicinity of the hitch head 12 and kingpin 14.

FIGS. 2-3 illustrate the sleeve 16 of the present invention. The sleeve 16 slides over the hitch head 12 and kingpin 14. FIG. 2 shows the sleeve 16 after it has been slid onto the hitch head 12 and kingpin 14. FIG. 3 illustrates how the sleeve 16 slides onto the hitch 11, providing substantially full coverage of the hitch head 12 and kingpin 14.

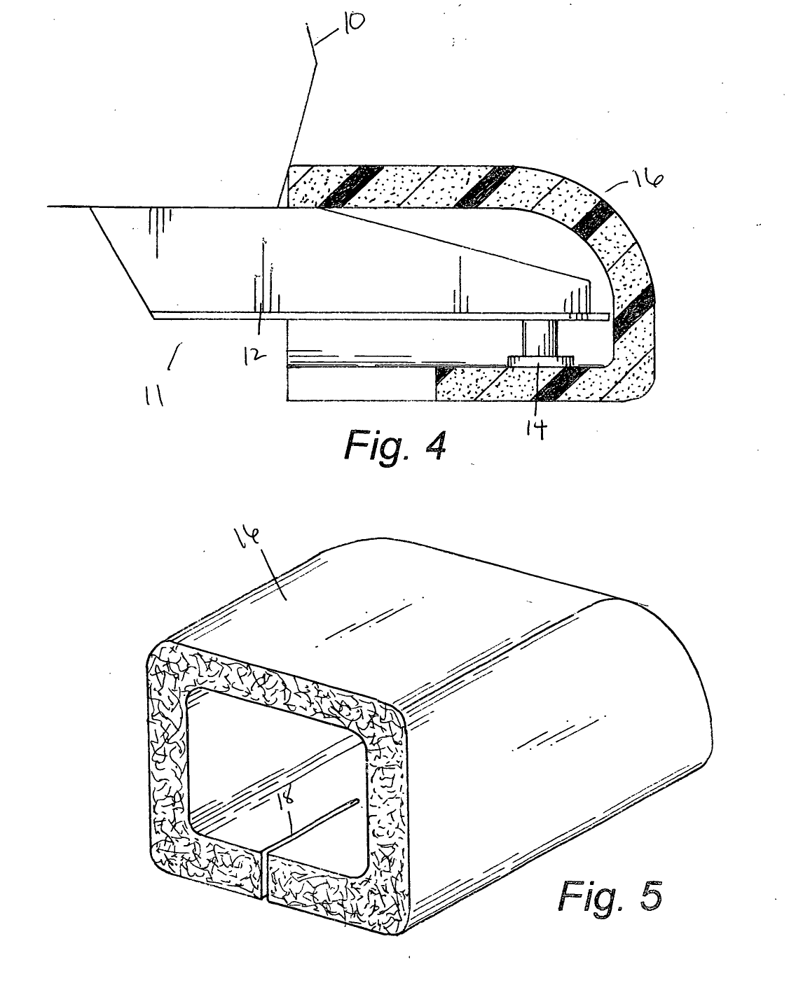

As seen in FIG. 4, the length of the sleeve 16 is such that it covers the entire hitch head 12 and kingpin 14 from where the top of the hitch head 12 emerges from the trailer 10. This substantially full coverage of the hitch head 12 protects individuals form injury due to collision with the hitch head 12, in addition to collision with the kingpin 14. The sleeve 16 is generally in the shape of the hitch 11, such that the sleeve fits snugly against the kingpin 14. There may be extra space between the sleeve 16 and the bottom of the hitch head 12.

In one embodiment, as seen in FIG. 5, the sleeve 16 includes a slit 18 on the bottom (ground side) of the sleeve 16 to make installation of the sleeve 16 easier. The slit 18 eases the sliding of the sleeve 16 over the kingpin 14.

The sleeve 16 is constructed from a cushioning material to protect people from injury sustained when colliding with the hitch head 12 or kingpin 14. In one embodiment, the sleeve is constructed from foam rubber, or a similar soft, dense, resilient material. The material may also be water-resistant.

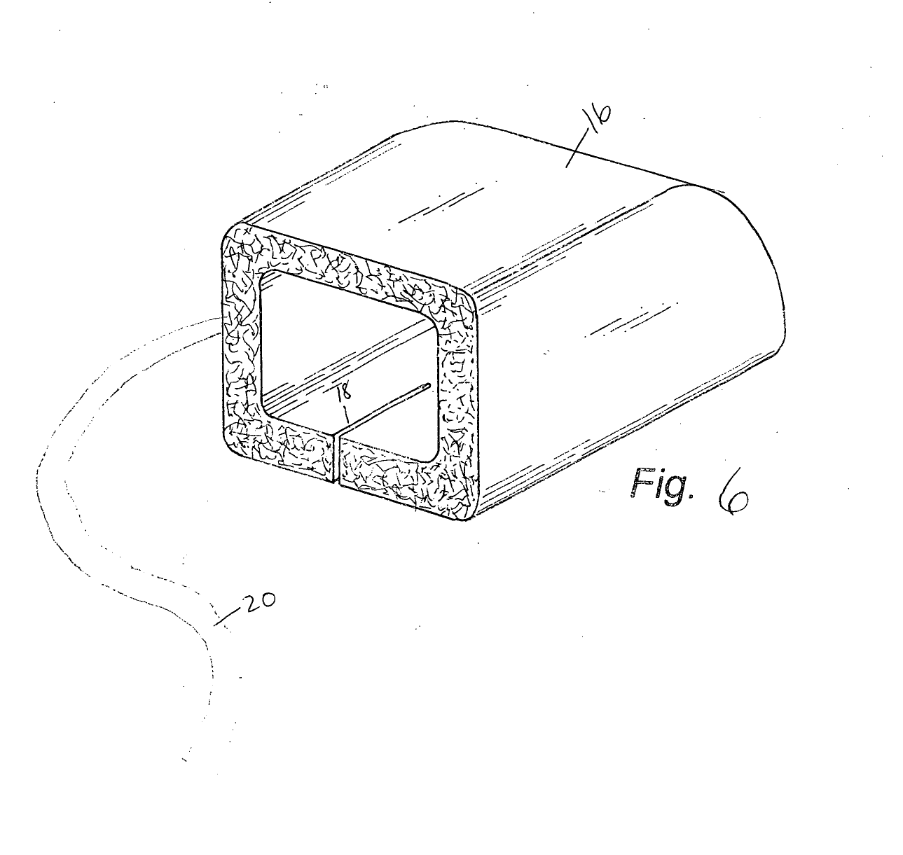

In FIG. 6, a strap 20 is provided to securely attach the sleeve 16 to the hitch head 12.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

1. A cover for the hitch head and kingpin of a fifth wheel trailer, comprising a sleeve having an upper and a lower surface, wherein the sleeve is adapted to surround substantially all of the hitch head and kingpin.

2. The cover in accordance with claim 1 wherein said sleeve is conical.

3. The cover in accordance with claim 1 wherein said sleeve has a partial slit in the lower surface.

4. The cover in accordance with claim 1 wherein said sleeve is made of a protective material.

5. The cover in accordance with claim 1 wherein said sleeve is made of a soft, resilient material.

6. The cover in accordance with claim 1 wherein said sleeve is made of a water-resistant material.

7. The cover in accordance with claim 1 wherein said sleeve is made of an impact-resistant material.

8. The cover in accordance with claim 1 wherein said sleeve is made of foam rubber.

9. The hitch cover in accordance with claim 1 wherein the sleeve includes a securing strap adapted to wrap around the hitch head.
